(19) United States
(12) Patent Application Publication
(10) Pub. No.: US 2010/0297512 A1
(43) Pub. Date: Nov. 25, 2010

(54) FUEL CELL SYSTEM

(76) Inventors: Kazunobu Shinoda, Toyota-shi (JP); Keiji Suzumura, Toyota-shi (JP); Tsuyoshi Yamada, Toyota-shi (JP)

Correspondence Address: KENYON & KENYON LLP, 1500 K STREET N.W., SUITE 700, WASHINGTON, DC, 20005, US

(21) Appl. No.: 12/445,861

(22) PCT Filed: Oct. 3, 2007
(86) PCT No.: PCT/JP2007/069790

§ 371 Date: Apr. 16, 2009

(30) Foreign Application Priority Data
Oct. 20, 2006 (JP) 2006-286807

(51) Int. Cl. H01M 8/06; H01M 8/04

(52) U.S. Cl. 429/423; 429/513

(57) ABSTRACT

A fuel-cell system is advantageous in preventing exhaust gases to be discharged from an exhaust port from flowing back into an exhaust gas passage without being discharged from the exhaust port. This fuel cell system includes a fuel cell having an anode and a cathode, and an exhaust gas passage having an exhaust port for discharging exhaust gases generated during operation of the fuel cell to the outside. The exhaust gas passage has a backflow suppressing unit at an end portion of the exhaust gas passage on the side of the exhaust port.

### TECHNICAL FIELD

The present invention relates to a fuel cell system including an exhaust gas passage having an exhaust port for discharging exhaust gases generated during operation of a fuel cell to the outside.

### BACKGROUND ART

Generally, a fuel cell system includes fuel cells, an anode fluid supply unit for supplying anode fluid to anodes of the fuel cells, a cathode fluid supply unit for supplying cathode fluid to cathodes of the fuel cells, and an exhaust gas passage having an exhaust port for discharging exhaust gases generated during operation of the fuel cells to the outside. In such a fuel cell system, Patent Document 1 discloses a fuel cell system provided with a filter in a vent hole of a casing for accommodating the fuel cells.
[Patent Document 1] Japanese Unexamined Patent Publication No. 2006-140,165

### DISCLOSURE OF INVENTION

When an outside wind blows into the exhaust gas passage through the exhaust port disposed at an end of the exhaust gas passage, there is a fear that exhaust gases to be discharged from the exhaust port may not be discharged from the exhaust port and flow back. In this case, there is a fear that the fuel cell system cannot exhibit sufficient electric power generation performance. For example, there is a fear that combustion stability of a combustion unit such as a burner used in the fuel cell system may be impaired.

The present invention has been conceived under the above circumstances. It is an object of the present invention to provide a fuel cell system which is advantageous in suppressing exhaust gases to be discharged from the exhaust port from flowing back into the exhaust gas passage without being discharged from the exhaust port.

A fuel cell system according to a first aspect of the present invention includes a fuel cell having an anode and a cathode, an anode fluid supply unit for supplying anode fluid to the anode of the fuel cell, a cathode fluid supply unit for supplying cathode fluid to the cathode of the fuel cell, and an exhaust gas passage having an exhaust port for discharging exhaust gases generated during operation of the fuel cell to the outside, the exhaust gas passage including a backflow suppressing unit at an end portion of the exhaust gas passage on the side of the exhaust port.

The backflow suppressing unit is a means for preventing exhaust gases to be discharged from the exhaust port of the exhaust gas passage from flowing back into the exhaust gas passage without being discharged from the exhaust port under influence of winds blowing outside of the exhaust gas passage when the fuel cell system is in operation or not in operation. Since such a backflow suppressing unit is provided at an end portion of the exhaust gas passage on the side of the exhaust port, outside winds are suppressed from entering the exhaust gas passage through the exhaust port. Therefore, exhaust gases to be discharged from the exhaust port are suppressed from flowing back into the exhaust gas passage without being discharged from the exhaust port.

According to a second aspect of the present invention, in the fuel cell system of the first aspect, the backflow suppressing unit is formed of a baffle member facing the exhaust port. Since such a baffle member is provided at the end portion of the exhaust gas passage on the side of the exhaust port, outside winds are suppressed from entering the exhaust gas passage through the exhaust port. Therefore, the exhaust gases to be discharged from the exhaust port are suppressed from flowing back into the exhaust gas passage without being discharged from the exhaust port.

According to a third aspect of the present invention, in the fuel cell system of the first aspect, the backflow suppressing unit is formed by bending a passage portion disposed at the side of the exhaust port in the exhaust gas passage. Since such a backflow suppressing unit is provided at the end portion of the exhaust gas passage on the side of the exhaust port, outside winds are suppressed from entering the exhaust gas passage through the exhaust port. Therefore, the gases to be discharged from the exhaust port are suppressed from flowing back into the exhaust gas passage without being discharged from the exhaust port.

As described above, the fuel cell system of the present invention has the following advantages: Since such a backflow suppressing unit as described above is provided at the end portion of the exhaust gas passage on the side of the exhaust port, winds blowing outside of the exhaust gas passage are suppressed from entering the exhaust gas passage through the exhaust port, and the gases to be discharged from the exhaust port are suppressed from flowing back into the exhaust gas passage without being discharged from the exhaust port. As a result, the fuel cell system can exhibit good electric power generating performance.

### BRIEF DESCRIPTION OF DRAWINGS

FIG. 1 is a perspective view of an exhaust duct, which is an end portion of an exhaust gas passage on the side of an exhaust port, according to a first preferred embodiment of the present invention.

FIG. 2 is a perspective view showing component parts of the exhaust duct of the first preferred embodiment before being assembled.

FIG. 3 is a front view of the exhaust duct of the first preferred embodiment.

FIG. 4 is a schematic diagram of a fuel cell system of the first preferred embodiment.

FIG. 5 is a side view of the exhaust duct of the first preferred embodiment.

FIG. 6 is a perspective view of the exhaust duct of the first preferred embodiment, taken from a different angle from that of FIG. 1.

FIG. 7 is a side view of an exhaust duct according to a second preferred embodiment of the present invention.

FIG. 8 is a side view of an exhaust duct according to a third preferred embodiment of the present invention.

FIG. 9 is a side view of an exhaust duct according to a fourth preferred embodiment of the present invention.

FIG. 10 is a perspective view of the exhaust duct according to the fourth preferred embodiment.

FIG. 11 is a cross sectional view of an exhaust duct according to a fifth preferred embodiment of the present invention.

FIG. 12 is a system chart showing a fuel cell system according to a sixth preferred embodiment of the present invention.

FIG. 13 is a system chart showing a fuel cell system according to a seventh preferred embodiment of the present invention.

FIG. 14 is a side view of an exhaust duct according to an eighth preferred embodiment of the present invention.

### BEST MODE FOR CARRYING OUT THE INVENTION

A fuel cell system according to the present invention includes a fuel cell having an anode and a cathode, an anode fluid supply unit for supplying anode fluid to the anode of the fuel cell, a cathode fluid supply unit for supplying cathode fluid to the cathode of the fuel cell, and an exhaust gas passage having an exhaust port for discharging exhaust gases generated during operation of the fuel cell to the outside. The anode fluid supply unit can be anything as long as it supplies anode fluid to the anode of the fuel cell. The cathode fluid supply unit can be anything as long as it supplies cathode fluid to the cathode of the fuel cell. The exhaust gas passage includes a backflow suppressing unit at an end portion of the exhaust gas passage on the side of the exhaust port. The backflow suppressing unit is a means for preventing exhaust gases to be discharged from the exhaust port from flowing back into the exhaust gas passage without being discharged from the exhaust port under influence of outside winds or the like. When the backflow suppressing unit is provided at the end portion of the exhaust gas passage on the side of the exhaust port, the backflow suppressing unit is located close to the exhaust port. Therefore, outside winds are effectively suppressed from entering the exhaust gas passage through the exhaust port.

In an exemplary embodiment, the backflow suppressing unit is a baffle member facing the exhaust port. In another exemplary embodiment, the backflow suppressing unit is formed by bending a passage portion of the exhaust gas passage in proximity to the exhaust port. Also in these cases, outside winds can effectively be suppressed from entering the exhaust gas passage through the exhaust port. Examples of the material of the baffle member include metal, resin and ceramics.

In an exemplary embodiment, the exhaust gas passage comprises a first exhaust gas passage connected to a combustion unit, and a second exhaust gas passage having the exhaust port and having a larger flow passage cross sectional area than that of the first exhaust gas passage. In this case, the end portion of the exhaust gas passage on the side of the exhaust port is the second exhaust gas passage. In this case, in an exemplary embodiment, the second exhaust gas passage has a container shape including a box shape. The box shape can be the shape of a rectangular box or the shape of a cylindrical box. Since the second exhaust gas passage has a larger flow passage cross sectional area, the flow rate of the exhaust gases is decreased and the inner pressure of the exhaust gas passage is increased. This is advantageous in suppressing outside air from entering the exhaust gas passage through the exhaust port.

In an exemplary embodiment of the present invention, the anode fluid supply unit includes a reforming unit for generating anode gas to be supplied to the anode of the fuel cell from a fuel raw material, and a combustion unit for heating the reforming unit. In this case, in an exemplary embodiment, the end portion of the exhaust gas passage on the side of the exhaust port has a mixing room for mixing combustion exhaust gas discharged from the combustion unit and cathode off-gas discharged from the cathode of the fuel cell. After the combustion exhaust gas and the cathode off-gas are mixed together, the mixture is discharged from the exhaust port. In this case, the concentration of the combustion exhaust gas is reduced by the cathode off-gas (air, for instance).

In an exemplary embodiment of the present invention, the fuel cell system includes a condenser for producing condensed water, and the end portion of the exhaust gas passage on the side of the exhaust port discharges condensed water present in the end portion by gravity or returns the condensed water to the condenser by gravity. The condensed water returned to the condenser can be reused.

In an exemplary embodiment, when the baffle member and the exhaust port are projected in a vertical direction to the baffle member and the exhaust port, the shape of a projection of the baffle member overlaps that of the exhaust port and the area of the projection of the baffle member is larger than that of the exhaust port. In this case, the baffle member suppresses outside winds from entering the exhaust gas passage through the exhaust port, and this is advantageous in suppressing the exhaust gases from flowing back.

In an exemplary embodiment, the baffle member comprises a first baffle portion extending in an extending direction of the exhaust port and facing the exhaust port, and a second baffle portion connected to an end portion of the first baffle portion and extending in a crosswise direction to the extending direction of the exhaust port. This is advantageous in suppressing exhaust gases from flowing back. In another exemplary embodiment, the baffle member has a height greater than that of a top portion of the exhaust port. In this case, outside winds are suppressed from entering the exhaust gas passage through the exhaust port and this is advantageous in suppressing the exhaust gases from flowing back.

In an exemplary embodiment, the baffle member has a heat exchange fin. Since the heat exchange fin increases the surface area of the baffle member, when the exhaust gases are warm, it is advantageous in cooling the exhaust gases by the baffle member and condensing water vapor contained in the exhaust gases in the vicinity of the heat exchange fin to produce condensed water. Therefore, the water vapor contained in the exhaust gases to be discharged to the outside can be reduced. When the baffle member faces the exhaust port, the baffle member is easily cooled by outside air and accordingly, the heat exchange fin can easily exhibit good cooling performance. When the exhaust gases are warm, this is advantageous in cooling the exhaust gases by the heat exchange fin of the baffle member and in condensing the water vapor contained in the exhaust gases to produce condensed water. In this case, exhaust gases having a lower water content can be emitted to the outside. Note that if water vapor in the exhaust gases immediately after being emitted to the outside of the fuel cell system is condensed at the outside, there is a fear that condensed water and dust may be mixed and make a housing of the fuel cell system dirty. Therefore, it is preferable to reduce the water content of the exhaust gases to be discharged from the exhaust port to the outside (outside air) as much as possible.

By the way, when the fuel cell system is not in operation, there is a fear that winds blowing outside of the exhaust gas passage may enter the exhaust gas passage through the exhaust port of the exhaust gas passage. In this case, there is a fear that dust or the like may enter the exhaust gas passage. Under these circumstances, in an exemplary embodiment, the backflow suppressing unit includes a gas discharging unit for suppressing outside air from entering the exhaust gas passage through the exhaust port by discharging a gas such as air from the exhaust port when the fuel cell system is not in operation. In this case, winds are suppressed from entering the exhaust gas passage through the exhaust port of the exhaust gas passage. When the fuel cell system is not in operation, the gas discharging unit can discharge a gas such as air from the exhaust port to the outside upon actuation of a gas feeding source such as a pump and a fan.

In an exemplary embodiment of the present invention, the backflow suppressing unit includes a wind pressure sensor provided in the end portion of the exhaust gas passage on the side of the exhaust port and when the fuel cell system is not in operation, the flow rate of the gas to be discharged per unit time from the exhaust port is determined based on wind pressure of an outside wind detected by the wind pressure sensor. In this case, since the power to drive the gas feeding source per unit time can be controlled based on the detected wind pressure, winds or the like are suppressed from entering the exhaust gas passage through the exhaust port.

### First Preferred Embodiment

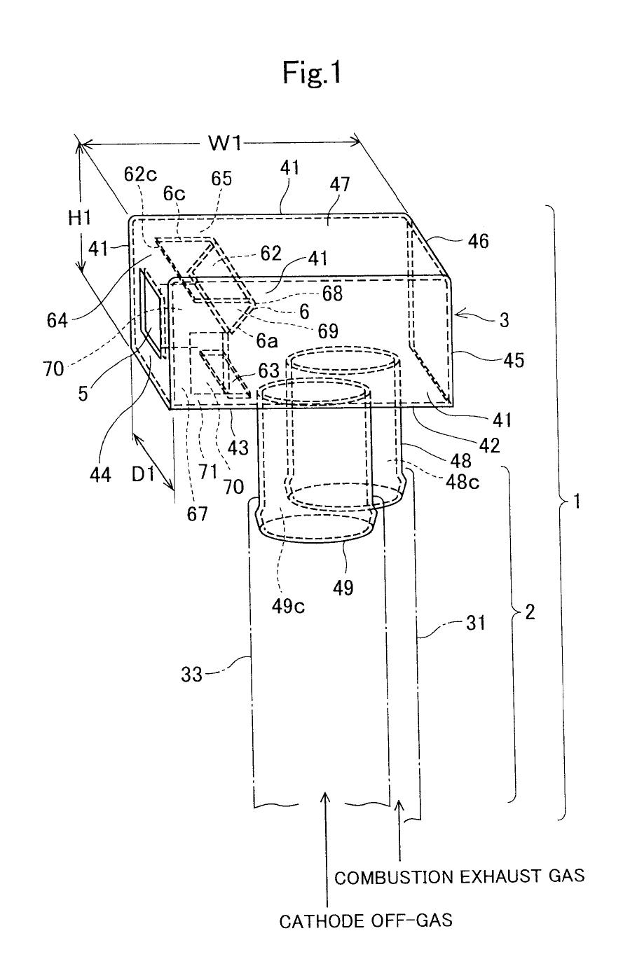

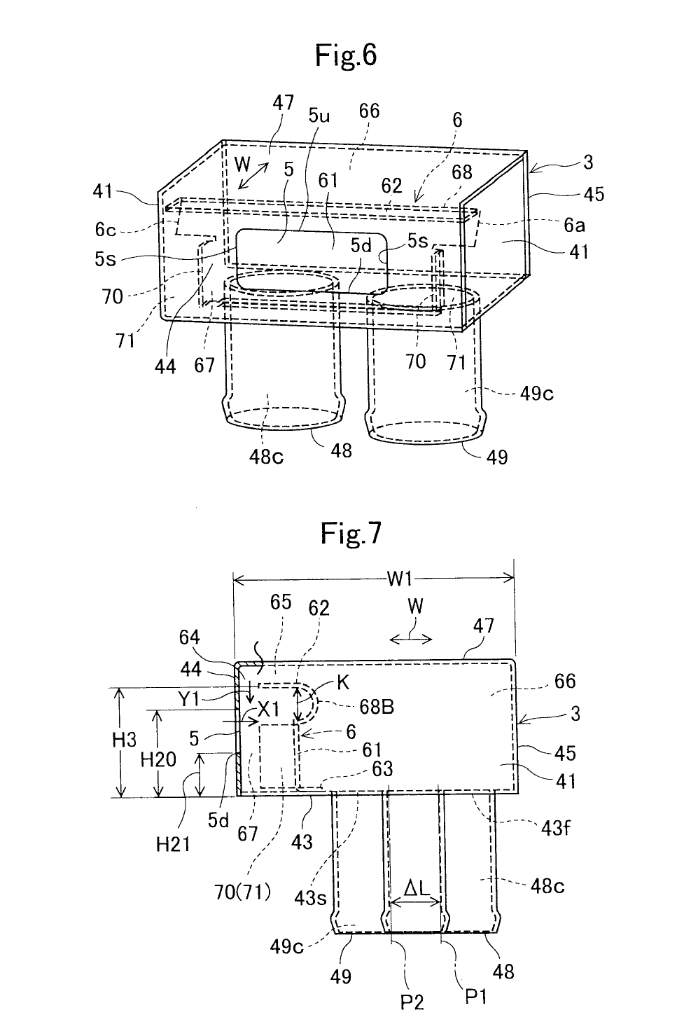

A first preferred embodiment of the present invention will be described below referring to FIGS. 1 to 6. A fuel cell system according to this preferred embodiment includes an exhaust gas passage 1 for discharging exhaust gases from the fuel cell system when the system is in operation. The exhaust gas passage 1 comprises a first exhaust gas passage 2 for discharging exhaust gases from the fuel cell system and an exhaust duct 3 provided at a downstream end portion of the first exhaust gas passage 2 and serving as a second exhaust gas passage. The exhaust duct 3 has an exhaust port 5. The exhaust duct 3 is an end portion of the exhaust gas passage 1 on the side of the exhaust port 5.

The first exhaust gas passage 2 comprises a combustion exhaust gas passage 31 for passing combustion exhaust gas discharged from a combustion unit 102 of a reformer 100 after combustion, and a cathode off-gas passage 33 for passing cathode off-gas discharged from cathodes 142 of fuel cells 140 after power generating reaction. The combustion exhaust gas passage 31 and the cathode off-gas passage 33 are separated from each other.

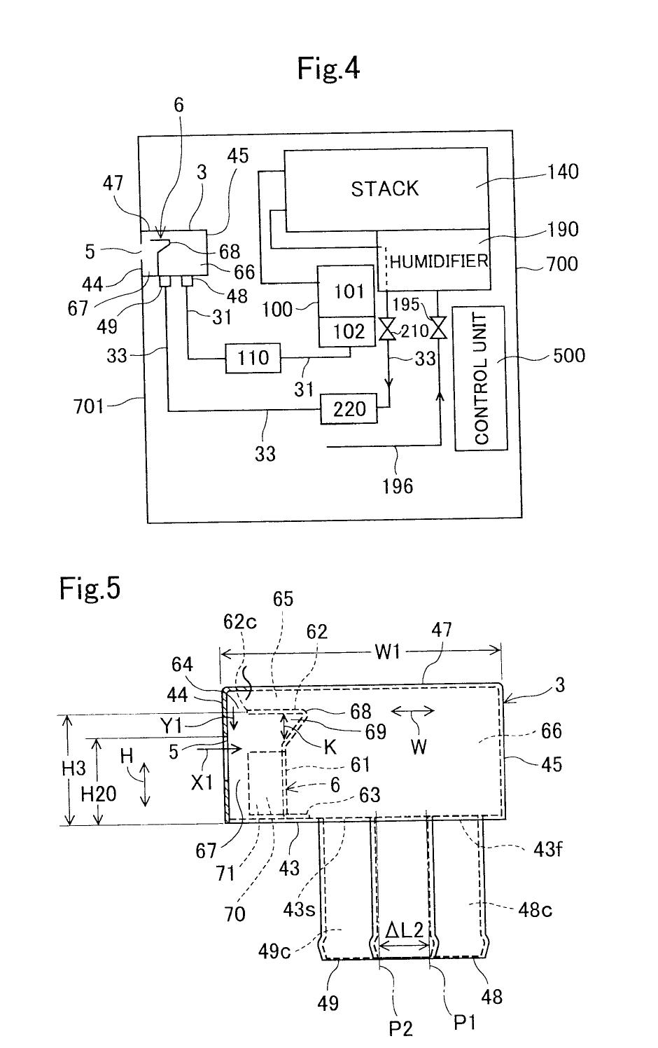

FIG. 4 shows the concept of the fuel cell system. As shown in FIG. 4, a box-shaped housing 700 encloses the reformer 100 including the reforming unit 101 and a combustion unit 102, the fuel cells 140 constituting a stack, a humidifier 190, a control unit 500, the exhaust duct 3, a combustion exhaust gas condenser 110 for condensing water vapor contained in combustion exhaust gas, a cathode condenser 220 for condensing water vapor contained in cathode off-gas, the combustion exhaust gas passage 31 for passing combustion exhaust gas discharged from the combustion unit 102 of the reformer 100 after combustion, the cathode off-gas passage 33 for passing cathode off-gas discharged from the cathodes of the fuel cells 140 after power generating reaction, and other various auxiliary devices.

As shown in FIG. 4, the exhaust duct 3 is located vertically above condensers such as the combustion exhaust gas condenser 110 and the cathode condenser 220. This is to return, by gravity, condensed water produced in the exhaust duct 3 to the combustion exhaust gas condenser 110 through the combustion exhaust gas passage 31 or to the cathode condenser 220 through the cathode off-gas passage 33.

As shown in FIG. 1, the exhaust duct 3 serving as a second exhaust gas passage has a box shape (a rectangular box shape) and is an end portion of the exhaust gas passage 1 for discharging exhaust gases of the fuel cell system on the side of the exhaust port 5.

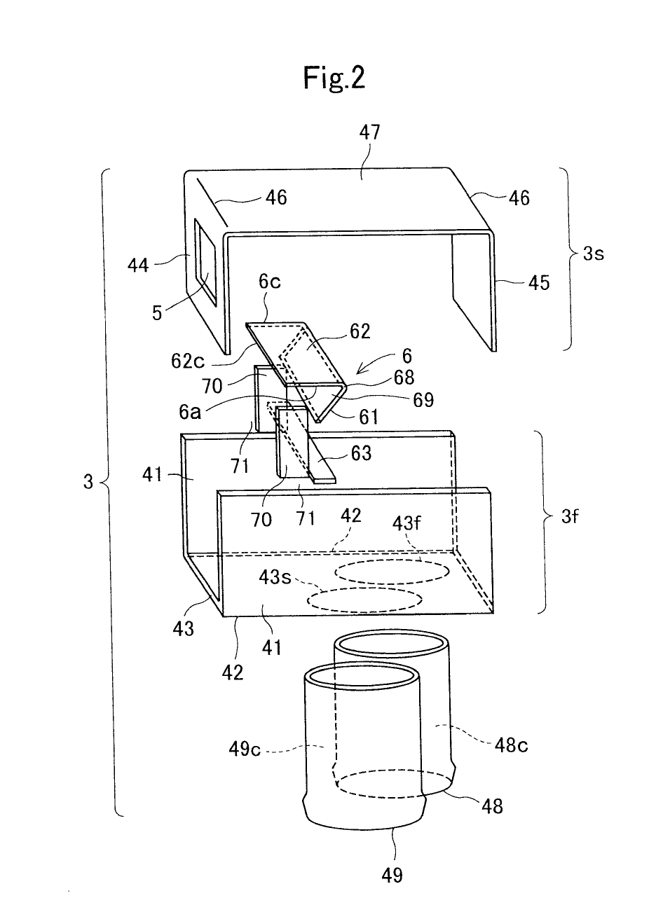

As shown in FIG. 2, the exhaust duct 3 comprises two first side walls 41 facing each other, a bottom wall 43 connecting the two first side walls 41 by way of straight first fold line areas 42, a front wall 44 and a rear wall 45 facing each other, and a top wall 47 connecting the front wall 44 and the rear wall 45 by way of straight second fold line areas 46. Moreover, the exhaust duct 3 includes a first cylindrical body 48 communicating with a first through hole 43f of the bottom wall 43, and a second cylindrical body 49 communicating with a second through hole 43s of the bottom wall 43. Here, as shown in FIG. 2, a first raw material 3f having a U-shaped cross section is used for the two first side walls 41 and the bottom wall 43 connected with each other by way of the straight first fold line areas 42. A second raw material 3s having a U-shaped cross section is used for the front wall 44, the rear wall 45 and the top wall 47 connected with each other by way of the straight second fold line areas 46. Furthermore, the first cylindrical body 48 and the second cylindrical body 49 are used. The exhaust duct 3 is airtightly formed by welding the first raw material 3f, the second raw material 3s, the first cylindrical body 48 and the second cylindrical body 49 together with a baffle member 6. Owing to the employment of such welding structure, the exhaust duct 3 is simple in structure.

As shown in FIG. 1, the exhaust port 5 is formed in the front wall 44 of the exhaust duct 3. When exhaust gases to be discharged from the exhaust port 5 contain water vapor, there is a fear that exhaust gases discharged from the exhaust port 5 may be cooled outside the exhaust duct 3 to produce condensed water and that dust deposited on the front wall 44 and the condensed water may make the front wall 44 dirty. Therefore, it is preferable that the water vapor contained in the exhaust gases is removed before the exhaust gases are discharged from the exhaust port 5 to the outside (the outside of the housing 700).

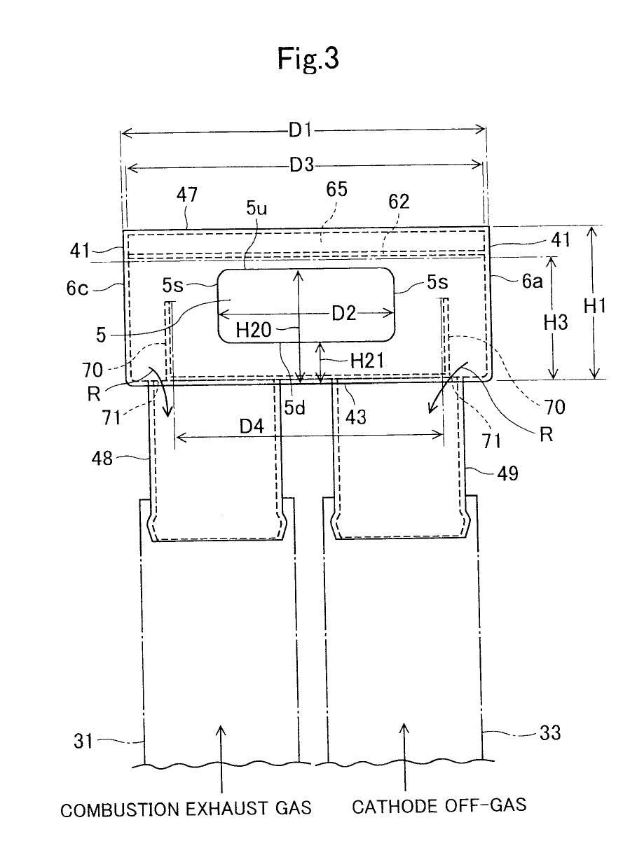

Here, as shown in FIG. 1, the exhaust duct 3 has a height H1 from the bottom wall 43, a width D1 and a depth W1. As shown in FIG. 3, the exhaust port 5 has the shape of a landscape-oriented rectangle and has an upper side portion 5u, a lower side portion 5d, and left and right side portions 5s. The top portion (the upper side portion 5u) of the exhaust port 5 has a height H20 from the bottom wall 43. The bottom portion (the lower side portion 5d) of the exhaust port 5 has a height H21 from an under surface of the bottom wall 43. The exhaust port 5 has a width D2.

Moreover, as shown in FIGS. 1 to 3, the exhaust duct 3 includes the first cylindrical body 48 having a cylindrical shape and the second cylindrical body 49 having a cylindrical shape both connected to the bottom wall 43 by welding. The first cylindrical body 48 and the second cylindrical body 49 are provided in parallel with each other in a manner to extend from the bottom wall 43 in a vertically downward direction so that condensed water drops down by gravity. The first cylindrical body 48 is connected to an end portion of the combustion exhaust gas passage 31 for discharging combustion exhaust gas from the combustion unit 102 of the reformer 100 to the outside air. The second cylindrical body 49 is connected to an end portion of the cathode off-gas passage 33 for discharging the cathode off-gas from the cathodes 142 of the fuel cells 140 to the outside air.

As shown in FIG. 5, because of the configuration inside the fuel cell system, an axis P1 of the first cylindrical body 48 and an axis P2 of the second cylindrical body 49 are offset by LL2 in the depth direction of the exhaust duct 3 (the direction of the arrow W1). Since the first cylindrical body 48 is thus offset in the opposite direction to the exhaust port 5, the volume of a mixing chamber 66, which will be mentioned later, can be increased.

As shown in FIGS. 1 to 6, the baffle member 6 constituting a backflow suppressing unit is provided inside the exhaust duct 3, which is an end portion of the exhaust gas passage 1. The baffle member 6 stands in the exhaust duct 3 so as to extend approximately in a vertically upward direction from the bottom wall 43. As shown in FIG. 1, one lateral end portion 6a of the baffle member 6 is fixed by welding to one of the side walls 41 of the exhaust duct 3. The other lateral end portion 6c of the baffle member 6 is fixed by welding to the other of the side walls 41 of the exhaust duct 3. A connecting plate 63, which is a bottom portion of the baffle member 6, is fixed by welding to the bottom wall 43.

In this preferred embodiment, as shown in FIG. 5, the baffle member 6 comprises a first baffle portion 61 extending in the extending direction of the exhaust duct 5 (in the direction of the arrow H) and facing the exhaust port 5, and a second baffle portion 62 connected to an end portion (an upper end portion) of the first baffle portion 61. The connecting plate 63 is provided at a lower end portion of the first baffle member 61. The connecting plate 63 is fixed by welding to the bottom wall 43 of the exhaust duct 3, and the first baffle portion 61 stands on the bottom wall 43. The second baffle portion 62 is bent in an opposite direction to the connecting plate 63, that is, toward the exhaust port 5. Note that the first baffle portion 61, the second baffle portion 62, the connecting plate 63 and wing walls 70 are formed by bending a piece of plate and these parts constitute the baffle member 6.

The baffle member 6 will be described in more detail. As shown in FIG. 5, the second baffle portion 62 extends in a crosswise direction (the direction of the arrow W) to the extending direction of the exhaust duct 5 (the direction of the arrow H), that is to say, extends in an approximately horizontal direction so as to be approximately in parallel to the bottom wall 43 and the top wall 47. Since a fore end portion 62c of the second baffle portion 62 does not reach the front wall 44 of the exhaust duct 3, a last passage 64 just before the exhaust port 5 is formed between the fore end portion 62c of the second baffle portion 62 and the front wall 44 of the exhaust duct 3. In the last passage 64, the exhaust gases flow in a downward direction (the direction of the arrow Y1). On the other hand, outside winds blow into the exhaust duct 3 through the exhaust port 5 in the direction of the arrow X1 shown in FIG. 5. In this way, the basic direction of the last passage 64 (the direction of the arrow Y1) and the basic direction of winds blowing into the exhaust duct 3 through the exhaust port 5 (the direction of the arrow X1) are not directions to collide head on with each other but directions to cross each other. Therefore, even when outside winds enter from the exhaust port 5, the exhaust gases flowing through the last passage 64 and the outside winds entering from the exhaust port 5 are suppressed from colliding head on with each other. Therefore, this is advantageous in discharging the exhaust gases having flown through the last passage 64 of the exhaust duct 3 from the exhaust port 5 to the outside of the exhaust duct 3.

As shown in FIG. 3, an upper width D3 of the baffle member 6 is close to the width D1 of the exhaust duct 3 but smaller than the width D1 by the thickness of the side walls 41. A lower width D4 of the baffle member 6 is smaller than the width D1 of the exhaust duct 3 but greater than a width D2 of the exhaust port 5.

Therefore, the baffle member 6 stands close to and faces the exhaust port 5, and this configuration is advantages in suppressing outside winds from directly entering the exhaust duct 3 through the exhaust port 5. Particularly in this preferred embodiment, as shown in FIG. 3, a height H3 of the second baffle portion 62 of the baffle member 6 from the under surface of the bottom wall 43 is designed to be greater than the height H20 of the upper side portion 5u (the top portion) of the exhaust port 5 or the height H21 of the lower side portion 5d (the bottom portion) of the exhaust port 5. Therefore, the baffle member 6 stands close to the exhaust port 5 and covers the entire area of the exhaust port 5. This is particularly advantageous in suppressing winds from directly entering the exhaust duct 3 through the exhaust port 5. Moreover, as shown in FIG. 3, the exhaust port 5 is disposed between the two wing walls 70 facing each other. Namely, one of the wing walls 70 is disposed on one side of the exhaust port 5 and the other of the wing walls 70 is disposed on the other side of the exhaust port 5. As a result, the distance between the two wing walls 70 facing each other, which is close to the width D4, is designed to be greater than the width D2 of the exhaust port 5. Therefore, the wing walls 70 suppress winds from directly entering the exhaust duct 3 through the exhaust port 5.

In this preferred embodiment, as shown in FIG. 5, the baffle member 6 divides the inner space of the exhaust duct 3 into the mixing chamber 66 and an exhaust chamber 67. When the exhaust duct 3 has the depth W1, in a cross section taken along the direction for exhaust gases to flow through the exhaust port (shown in FIG. 7), the baffle member 6 is located in the vicinity of the exhaust port 5, namely, within the range of W1×½ from the exhaust port 5, and particularly preferably within the range of W1×⅓ from the exhaust port 5.

The mixing chamber 66 is located upstream of the baffle member 6 in the exhaust duct 3, and communicates with a passage 48c of the first cylindrical body 48 through the first through hole 43f and a passage 49c of the second cylindrical body 49 through the second through hole 43s. Since the mixing chamber 66 communicates with the passage 48c of the first cylindrical body 48 and the passage 49c of the second cylindrical body 49, the mixing chamber 66 serves as a chamber having much space volume for combining and mixing the cathode off-gas discharged from the cathodes 192 of the fuel cells 140 and the combustion exhaust gas discharged from the combustion unit 102 of the reformer 100. Here, the mixing chamber 66 of the exhaust duct 3 has a larger flow passage cross sectional area than the total cross sectional areas of the combustion exhaust gas passage 31 and the cathode off-gas passage 33 of the first exhaust gas passage 2.

As shown in FIG. 5, the exhaust chamber 67 stands close to and directly faces the exhaust port 5, and is located downstream of the baffle member 6 in the exhaust duct 3. Moreover, the space volume of the mixing chamber 66 is designed to be larger than that of the exhaust chamber 67. This is advantageous in mixing the combustion exhaust gas and the cathode off-gas and in reducing a concentration of the combustion exhaust gas with the cathode off-gas (to be concrete, air). Moreover, since the volume of the mixing chamber 66 is larger than that of the exhaust chamber 67, the inner pressure of the mixing chamber 66 can be increased and it is particularly advantageous in suppressing backflow from the exhaust port 5 to the mixing chamber 66.

In this preferred embodiment, as will be understood from FIG. 3 (a front view of the exhaust duct 3), when a projection is perpendicularly, along the arrow of X1 in FIG. 5, made from ahead of the surface of the front wall 44 of the exhaust duct 3 with respect to the baffle member 6 and the exhaust port 5, the shape of a projection of the baffle member 6 is designed to overlap that of the exhaust port 5, and the area of the projection of the baffle member 6 is designed to be larger than that of the exhaust port 5. Accordingly, the baffle member 6 stands close to and faces the exhaust port 5, and covers the entire portion of the exhaust port 5. This is advantageous in suppressing winds from directly entering the exhaust chamber 67 of the exhaust duct 3 through the exhaust port 5.

As shown in FIG. 5, an intermediate passage 65 is formed between the horizontally-extending second baffle portion 62 and the top wall 47. In an upper portion of the exhaust duct 3, the intermediate passage 65 extends in the direction of the arrow W (the depth direction) so that the mixing chamber 66 can communicate with the exhaust chamber 67 in a horizontal direction. As mentioned before, the height H3 of the second baffle portion 62 from the bottom wall 43 is designed to be greater than the height H20 of the upper side portion 5u (the top portion) of the exhaust port 5. Therefore, the intermediate passage 65 does not directly face the exhaust port 5 and is located above the upper side portion 5u of the exhaust port 5. Accordingly, even if winds blow in through the exhaust port 5, it is difficult for the winds to directly enter the intermediate passage 65.

As shown in FIG. 5, the mixing chamber 66, the intermediate passage 65, the last passage 64 and the exhaust port 5 are serially arranged in this order. Here, as mentioned before, the intermediate passage 65 extends in the direction of the arrow W and the last passage 64 extends in the direction of the arrow H. Accordingly, inside the exhaust duct 3, the gas flow direction is turned by about 90 degrees. In this preferred embodiment, the direction of a passage portion of the exhaust gas passage 1 in proximity to the exhaust port 5 is thus bent. This also contributes to suppressing outside winds from entering the exhaust duct 3, that is to say, flowing back to the exhaust duct 3 through the exhaust port 5.

In this preferred embodiment, if the mixing chamber 66 has a flow passage cross sectional area S66, the intermediate passage 65 has a flow passage cross sectional area S65, the last passage 64 has a flow passage cross sectional area S64, and the exhaust port 5 has a flow passage cross sectional area S5, then S66, S65, S64, and S5 are designed to satisfy the relationship: S66>S65, S64, or S5. Moreover, when S66 is a constant value α, values obtained by dividing each of the flow passage cross sectional areas with α, that is, (S65/α), (S64/α) and (S5/α) are all designed to fall in the range from 0.7 to 1.3, preferably in the range from 0.8 to 1.2, and more preferably in the range from 0.95 to 1.05. Namely, the respective flow passage cross sectional areas S65, S64, S5 are designed to be similar in size. Owing to this with pressure variation reduced as much as possible, exhaust gases obtained by mixing the combustion exhaust gas and the cathode off-gas in the mixing chamber 66 can be discharged to the outsice of the exhaust duct 3 through the exhaust port 5. Thus, this system can obtain good ability to discharge the exhaust gases. Note that the flow passage cross sectional areas mean cross sectional areas in a perpendicular direction to the gas flow direction.

In this preferred embodiment, as shown in FIG. 5, the first baffle portion 61 and the second baffle portion 62 are bent to have an approximately V-shaped cross section, and form a V-shaped receiving wall 68. The receiving wall 68 forms a receiving room 69 having an approximately V-shaped cross section (a cross section along the direction for the exhaust gases to flow through the exhaust port 5). As shown in FIG. 5, the receiving room 69 and the receiving wall 68 overlook the exhaust port 5 of the exhaust duct 3 from an upper level. The receiving room 69 is designed to have a smaller space width K as it goes away from the exhaust port 5. Therefore, even when outer winds enter the exhaust chamber 67 of the exhaust duct 3 through the exhaust port 5, this contributes to not only suppressing the winds from entering the mixing chamber 66 but also making the winds returned and discharged from the exhaust port 5 to the outside.

In this preferred embodiment, as shown in FIG. 1, the wing walls 70 on both the lateral ends of the baffle member 6 are bent towards the exhaust port 5. Owing to this, as shown in FIG. 3, one communicating port 71 is formed between one of the wing walls 70 and one of the first side walls 41. Similarly, the other communicating port 71 is formed between the other of the wing walls 70 and the other of the first side walls 41. The wing walls 70 of the baffle member 6 are fixed by welding to the bottom wall 43 of the exhaust duct 3. Since in the baffle member 6 the wing walls 70 and the connecting plate 63 at the bottom extend in the opposite directions to each other, supporting stability of the baffle member 6 is increased. Note that, as shown in FIG. 3, the width of the wing walls 70 is designed to be greater than that of the exhaust port 5. This suppresses winds from directly entering the exhaust duct 3. The communication ports 71 formed by the wing walls 70 allow communication between a lower portion of the mixing chamber 66 and a lower portion of the exhaust chamber 67 of the exhaust duct 3. Therefore, when condensed water is produced on the side of the exhaust chamber 67, the condensed water can be transferred through the communicating ports 71 to the mixing chamber 66 (in the direction of the arrow R shown in FIG. 3), and moreover can be made to drop down from the passage 48c of the first cylindrical body 48 and the passage 49c of the second cylindrical body 49. The first cylindrical body 48 is connected to the combustion exhaust gas condenser 110, while the second cylindrical body 49 is connected to the cathode off-gas condenser 220.

In this preferred embodiment, the baffle member 6 stands close to and faces the exhaust port 5. Therefore, the baffle member 6 is easily cooled by outside winds or the like. Moreover, when the baffle member 6 is formed of a metal plate having good heat conductivity and corrosion resistance, the baffle member 6 is good in terms of heat conductivity compared those formed of resins or ceramics. Therefore, when the combustion exhaust gas and the cathode off-gas supplied from the combustion exhaust gas passage 31 and the cathode off-gas passage 33 to the mixing chamber 66 of the exhaust duct 3 are warm and contain water vapor, the warm combustion exhaust gas and the warm cathode off-gas can be cooled by the baffle member 6. Thus, the baffle member 6 can function as a cooling member or a heat exchange member. In this case, there is a fear that condensed water may be produced on a surface of the baffle member 6 on the side of the mixing chamber 66. The condensed water thus produced drops down by gravity along the standing baffle member 6 and further drops down by gravity from the bottom portion of the mixing chamber 66 through the first cylindrical body 48 and the second cylindrical body 49 to the condenser 110 connected to the first cylindrical body 48 and the condenser 220 connected to the second cylindrical body 49. Note that water stored in the condensers 110, 220 becomes raw material water to be used for reforming reaction in the reformer 100, as will be mentioned later.

Furthermore, there is a fear that condensed water may also be produced on a surface of the baffle member 6 on the side of the exhaust chamber 67. In this case, when the combustion exhaust gas and the cathode off-gas supplied to the mixing chamber 66 are warm and cool outside air enters the exhaust duct 3 through the exhaust port 5, there is a fear that the warm gases may be cooled by the baffle member 6 and condensed water may be produced in the exhaust chamber 67. The water thus produced in the exhaust chamber 67 reaches the mixing chamber 66 through the communicating ports 71 and drops down by gravity from the bottom wall 43 of the mixing chamber 66 to the first cylindrical body 48 and the second cylindrical body 49 and further drops down to the condenser 110 and the condenser 220.

As described above, in this preferred embodiment, the baffle member 6 is provided in the exhaust duct 3, which is an end portion of the exhaust gas passage 1 on the side of the exhaust port 5. Therefore, outside winds are suppressed from entering the exhaust duct 3 through the exhaust port 5. Accordingly, backflow is effectively suppressed. Therefore, when the fuel cell system is in power generating operation, exhaust gases to be discharged from the exhaust port 5 are effectively suppressed from flowing back into the combustion exhaust gas passage 31 and the cathode off-gas passage 33 without being discharged from the exhaust port 5. Therefore, combustion stability is secured in the combustion unit 102 of the reformer 100.

Note that the bottom wall 43 can be downwardly slanted toward the first cylindrical body 48 and the second cylindrical body 49 so that water present on the bottom wall 43 can easily drop down into the first cylindrical body 48 and the second cylindrical body 49 by gravity.

### Second Preferred Embodiment

FIG. 7 shows a second preferred embodiment of the present invention. This preferred embodiment has basically the same construction, operation and effect as the first preferred embodiment. Hereinafter, differences will be mainly described. As shown in FIG. 7, a cross portion of the first baffle portion 61 and the second baffle portion 62, which constitute the baffle member 6, is bent so as to have a roughly U-shaped cross section, and forms a U-shaped receiving wall 68B. When outside winds enter the exhaust chamber 67 of the exhaust duct 3 through the exhaust port 5, this configuration contributes to not only suppressing the winds from entering the mixing chamber 66 but also making the winds returned and discharged from the exhaust port 5 to the outside. Thus, this is advantageous in suppressing backflow. Also in this preferred embodiment, as shown in FIG. 7, the height H3 of the second baffle portion 62 of the baffle member 6 from the under surface of the bottom wall 43 is designed to be greater than the height H20 of the upper side portion 5u (the top portion) of the exhaust port 5 or the height H21 of the lower side portion 5d (the bottom portion) of the exhaust port 5. This is further advantageous in suppressing winds from directly entering the exhaust chamber 67 of the exhaust duct 3 through the exhaust port 5.

### Third Preferred Embodiment

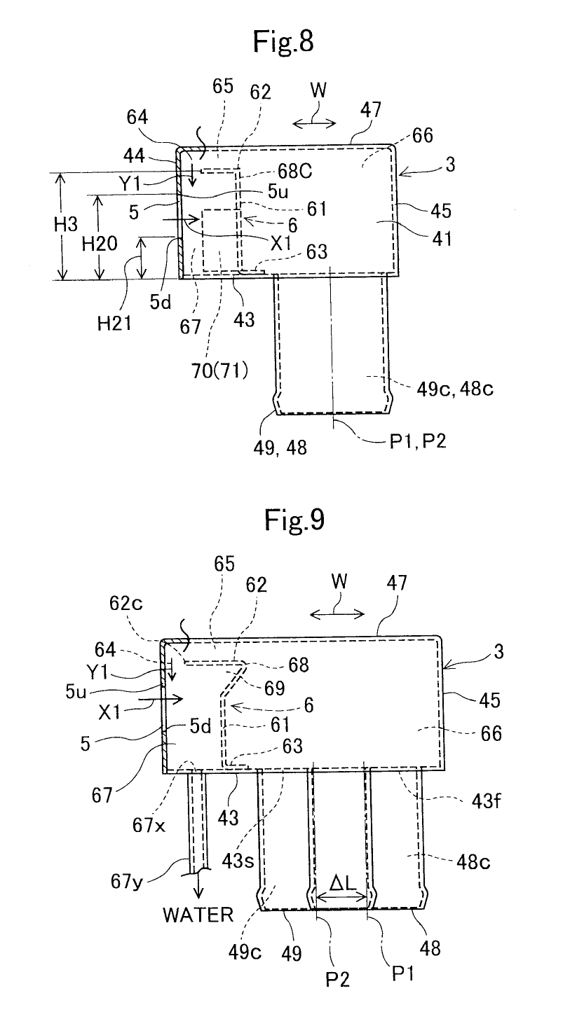

FIG. 8 shows a third preferred embodiment of the present invention. This preferred embodiment has basically the same construction, operation and effect as the first preferred embodiment. Hereinafter, differences will be mainly described. As shown in FIG. 8, the first baffle portion 61 of the baffle member 6 stands to extend in an approximately vertical direction from the bottom wall 43 of the exhaust duct 3. The second baffle portion 62 is bent with respect to the first baffle portion 61 so as to have an approximately L-shaped cross section and forms an L-shaped receiving wall 68C. When outside winds enter the exhaust chamber 67 of the exhaust duct 3 through the exhaust port 5, this configuration contributes to not only suppressing the winds from entering the mixing chamber 66 but also making the winds returned and discharged from the exhaust port 5 to the outside. This is advantageous in suppressing backflow.

Also in this preferred embodiment, as shown in FIG. 8, the height H3 of the second baffle portion 62 of the baffle member 6 from the bottom wall 43 is designed to be greater than the height H23 of the upper side portion 5u (the top portion) of the exhaust port 5 or the height H21 of the lower side portion 5d (the bottom portion) of the exhaust port 5. Therefore, outsides winds can be suppressed from directly entering the exhaust chamber 67 of the exhaust duct 3 through the exhaust port 5 and so this is particularly advantageous in suppressing backflow.

Moreover, as shown in FIG. 8, the axis P1 of the first cylindrical body 48 and the axis P2 of the second cylindrical body 49 are not offset in the depth direction of the exhaust duct 3 (the direction of the arrow W), that is to say, these axes are aligned with each other. This configuration can contribute to downsizing of the exhaust duct 3.

### Fourth Preferred Embodiment

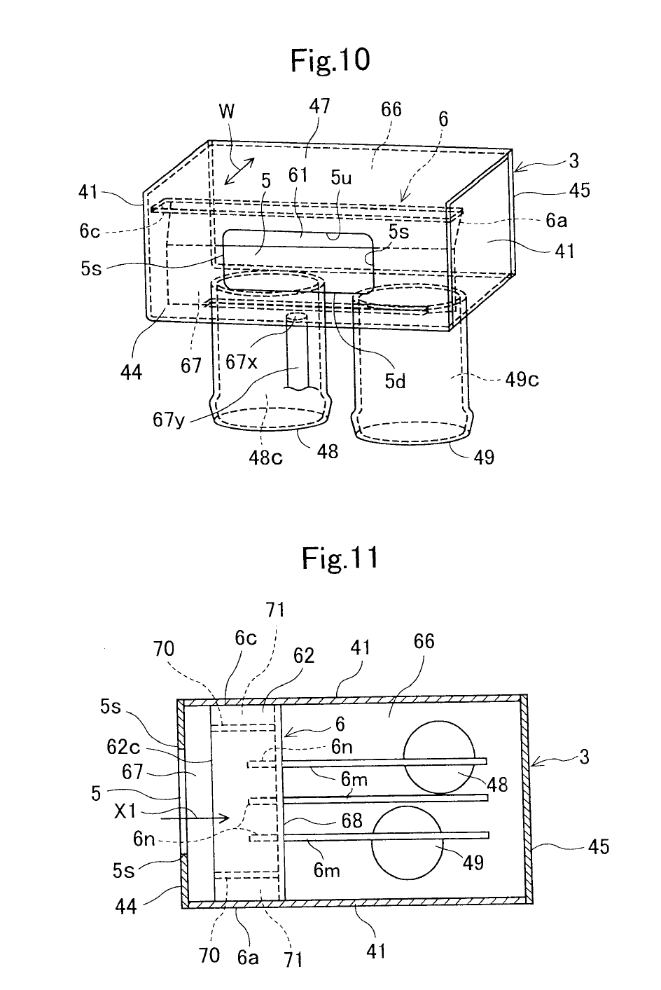

FIG. 9 and FIG. 10 show a fourth preferred embodiment of the present invention. This preferred embodiment has basically the same construction, operation and effect as the first preferred embodiment. Hereinafter, differences will be mainly described. As shown in FIG. 10, this baffle member 6 has no wing walls 70, and so there are no communicating ports 71. Therefore, in the exhaust duct 3, an upper portion of the exhaust chamber 67 on the side of the exhaust port 5 and an upper portion of the mixing chamber 66 communicate with each other through the intermediate passage 65, but a bottom portion of the exhaust chamber 67 and a bottom portion of the mixing chamber 66 do not communicate with each other and are blocked off from each other. Therefore, condensed water stored in the bottom of the exhaust chamber 67 does not flow into the mixing chamber 66. The exhaust chamber 67 has a drain hole 67x at the bottom and the water is discharged into a drain unit (not shown) through a drain pipe 67y such as an elastic hose. In this case, when the exhaust pipe 3 is used in an environment where dust together with incoming outside winds easily enters the exhaust chamber 67 from the exhaust port 5, condensed water containing dust is discharged to the drain unit.

### Fifth Preferred Embodiment

FIG. 11 shows a fifth preferred embodiment of the present invention. This preferred embodiment has basically the same construction, operation and effect as the first preferred embodiment. Hereinafter, differences will be mainly described. As shown in FIG. 11, the baffle member 6 has heat exchange fins 6m, 6n. The heat exchange fins 6m face the inside of the mixing chamber 66. The heat exchange fins 6m extend so as to be located above and overlapped with the first cylindrical body 48 and the second cylindrical body 49. The heat exchange fins 6n face the exhaust port 5 in the exhaust chamber 67. When winds enter the exhaust chamber 67 through the exhaust port 5 in the direction of the arrow X1, the heat exchange fins 6n are easily cooled.

Owing to the heat exchange fins 6m, 6n, the surface area of the baffle member 6 is increased. Therefore, when the exhaust gases having flown into the mixing chamber 66 are warm, the exhaust gases are cooled by the heat exchange fins 6m, 6n of the baffle member 6. This is advantageous in producing condensed water by condensing water vapor contained in the exhaust gases in the mixing chamber 66. The condensed water drops down through the first cylindrical body 48 and the second cylindrical body 49 and is collected. Since the heat exchange fins 6m extend long so as to be located above the first cylindrical body 48 and the second cylindrical body 49, this preferred embodiment has an advantage that condensed water drops down directly into the first cylindrical body 48 and the second cylindrical body 49. Note that it is possible to employ only the heat exchange fins 6m or the heat exchange fins 6n.

### Sixth Preferred Embodiment

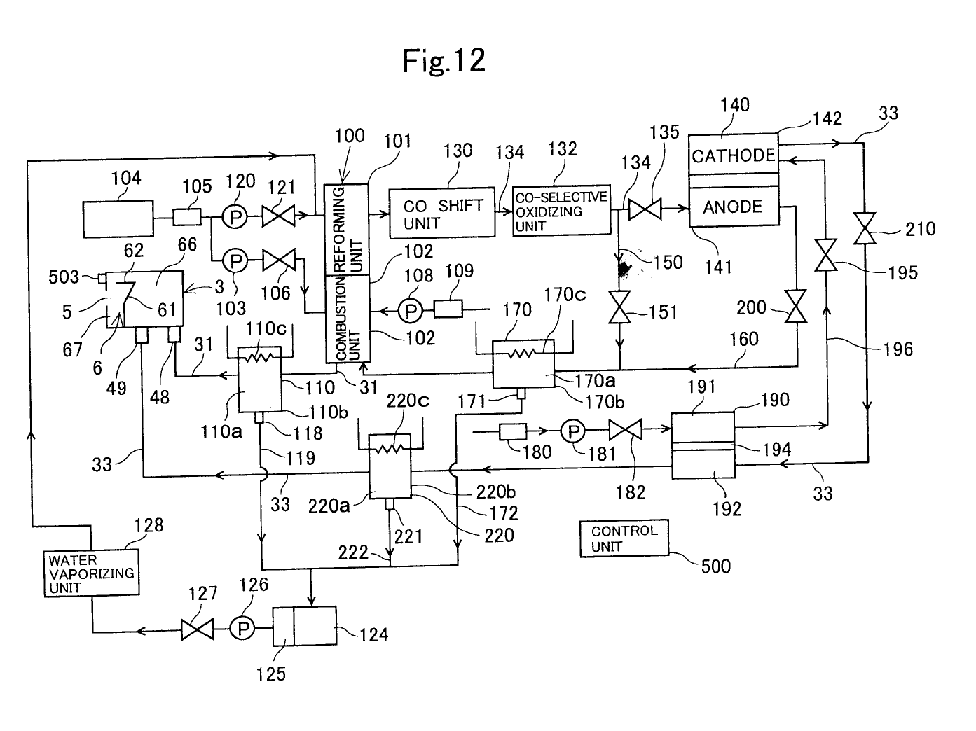

FIG. 12 shows a sixth preferred embodiment of the present invention. This preferred embodiment has basically the same construction, operation and effect as the first preferred embodiment. Hereinafter, differences will be mainly described. FIG. 12 shows a solid polymer membrane fuel cell system. Each of the fuel cells 140 is divided into an anode 141 and a cathode 142 by a solid polymer ion-conducting membrane (a solid polymer proton-conducting membrane). As shown in FIG. 12, an anode fluid supply unit includes the reformer 100 and an anode gas supply passage 134. The reformer 100 has the reforming unit 101, and the combustion unit 102 for heating the reforming unit 101 to high temperatures. Upon actuation of a pump (a fuel feeding source for combustion) 103, gaseous fuel (a raw material such as city gas) discharged from a fuel supply source 104 is supplied to the combustion unit 102 through a desulfurizer 105 and a fuel valve 106 for combustion. Upon actuation of a pump (an air supply source for combustion) 108, air to be used for combustion is supplied to the combustion unit 102 through a purifying unit 109 such as a filter. Then the fuel is burned in the combustion unit 102 and the combustion unit 102 heats the reforming unit 101 to high temperatures. Combustion exhaust gas in the combustion unit 102 flows through the combustion exhaust gas passage 31 and reaches the combustion exhaust gas condenser 110, where the combustion exhaust gas is cooled and its water content is reduced. Then, the cooled combustion exhaust gas flows through the combustion exhaust gas passage 31 to the first cylindrical body 48 of the exhaust duct 3 and is supplied to the mixing chamber 66.

When the reforming unit 101 is heated to a temperature suitable for reforming reaction, upon actuation of a pump (a fuel feeding source for reformation) 120, the gaseous fuel from the fuel supply source 104 is supplied to the reforming unit 101 through the desulfurizer 105, the pump (the fuel feeding source) 120 and a fuel valve 121 for reformation. Raw material water from a water tank 124 is changed into pure water by a water purifying unit (a water purification-promoting element) 125 having an ion-conductiong resin and then supplied to a water vaporizing unit 128 by a pump (a raw material water feeding source) 126 and a raw material water valve 127.

The raw material water is turned into water vapor in the high-temperature water vaporizing unit 128 and supplied to the reforming unit 101 together with fuel for reformation. In the reforming unit 101, a reforming reaction takes place under the presence of water vapor and the fuel, thereby producing hydrogen-rich reformed gas. The reformed gas is purified by removing carbon monoxide contained therein by a CO shift unit 130 and a CO-selective oxidizing unit 132. The CO-removed reformed gas flows through the anode gas supply passage 134 as anode gas and is supplied through an anode-side inlet valve 135 to an anode 141 of each of the fuel cells 140. However, in a start-up of the reformer 100, the composition of the reformed gas is not sufficiently stable. Therefore, the reformed gas produced in the reforming unit 101 bypasses the fuel cells 140 and is supplied to an anode off-gas passage 160 through a bypass passage 150 and a bypass valve 151 and reaches an anode condenser 170, where the reformed gas is cooled and its water content is reduced. Then the cooled reformed gas is supplied to the combustion unit 102 of the reformer 100 and burned in the combustion unit 102. As mentioned before, the combustion exhaust gas from the combustion unit 102 flows through the combustion exhaust gas passage 31 to the combustion exhaust gas condenser 110, where the combustion exhaust gas is cooled and its water content is reduced. Then the cooled combustion exhaust gas is supplied to the mixing chamber 66 of the exhaust duct 3 through the combustion exhaust gas passage 31 and the first cylindrical body 48 of the exhaust duct 3.

Next, a cathode fluid supply unit 196 will be described. Air for electric power generation is supplied through a filter 180 for purification, a pump (a cathode gas feeding source) 181, and a valve 182 to a supply passage 191 of a humidifier 190, and in the supply passage 191 of the humidifier 190 the air is humidified. Then the humidified air is supplied through a cathode-side inlet valve 195 to the cathode 142 of each of the fuel cells 140. Then the cathode gas and the anode gas make an electric power generating reaction in the fuel cells 140, thereby producing electric energy. The humidifier 190 has the supply passage 191 through which cathode gas before the power generating reaction flows, a return passage 192 through which cathode off-gas after the power generating reaction flows, and a water-holding membrane member 194 which divides the supply passage 191 and the return passage 192.

The anode off-gas discharged from the anode 141 of each of the fuel cells 140 after the power generating reaction sometimes contains combustible components. Therefore, the anode off-gas after the power generating reaction is made to flow through an anode-side outlet valve 200 and the anode off-gas passage 160 to the anode condenser 170, where the anode-off gas is cooled and its water content is reduced. Then the cooled anode-off gas is supplied to the combustion unit 102 and becomes combustion exhaust gas after combustion. Furthermore, the combustion exhaust gas flows through the combustion exhaust gas passage 31 to the combustion exhaust gas condenser 110, where the combustion exhaust gas is cooled and its water content is reduced. Then the combustion exhaust gas is supplied to the mixing chamber 66 of the exhaust duct 3 through the combustion exhaust gas passage 31 and the first cylindrical body 48 of the exhaust duct 3.

The cathode off-gas discharged from the cathode 142 of each of the fuel cells 140 after the power generating reaction flows through the cathode off-gas passage 33 and a cathode-side outlet valve 210 and reaches the return passage 192 of the humidifier 190, and in the return passage 192 of the humidifier 190 the cathode off-gas gives water and heat to the water holding membrane member 194, thereby removing its water content. Further, the cathode off-gas discharged from the return passage 192 of the humidifier 190 is cooled by the cathode condenser 220 and its water content is further reduced. Then the cooled cathode off-gas is supplied through the cathode off-gas passage 33 and the second cylindrical body 49 of the exhaust duct 3 to the mixing chamber 66 of the exhaust duct 3. In the power generating reaction in the fuel cells 140, water is produced in the cathode 142. The water also moves to the anode 141. Therefore, the cathode off-gas discharged from the cathode 142 of each of the fuel cells 140 and the anode off-gas discharged from the anode 141 of each of the fuel cells 140 generally contain water vapor in addition to heat.

As mentioned before, the exhaust duct 3 is located above the combustion exhaust gas condenser 110, the cathode condenser 220 and the anode condenser 170. This is to return condensed water produced in the exhaust duct 3 to the combustion exhaust gas condenser 110 and the cathode condenser 220 by gravity. On the other hand, the water tank 124 is located below the combustion exhaust gas condenser 110, the cathode condenser 220 and the anode condenser 170. This is to make condensed water drop down into the water tank 124 by gravity.

The anode condenser 170 has a third water drain valve 171 disposed in its bottom and a third water passage 172 connecting the third water drain valve 171 and the water tank 124. The anode condenser 170 has a condenser body 170b having a gas flow passage 170a, and a heat exchanger 170c through which cooling water as a cooling medium (a liquid cooling medium) for cooling the gas flow passage 170a flows. Since the warm anode off-gas having flown into the gas flow passage 170a is cooled by the cooling water of the heat exchanger 170c, saturated water vapor density is reduced and condensed water is produced in the gas flow passage 170a. When the condensed water in the gas flow passage 170a reaches a predetermined level, the third water drain valve 171 is opened so that the condensed water is supplied to the water tank 124 by gravity.

The combustion exhaust gas condenser 110 has a second water drain valve 118 formed at its bottom and a second water passage 119 connecting the second water drain valve 118 and the water tank 124. The combustion exhaust gas condenser 110 has a condenser body 110b having a gas flow passage 110a, and a heat exchanger 110c through which cooling water as a cooling medium (a liquid cooling medium) for cooling the gas flow passage 110a flows. Since warm combustion exhaust gas having flown into the gas flow passage 110a is cooled by the cooling water of the heat exchanger 110c, a saturated water vapor amount is reduced and condensed water is produced in the gas flow passage 110a. When the condensed water in the gas flow passage 110a reaches a certain level, the second water drain valve 118 is opened so that the condensed water is supplied to the water tank 124 by gravity.

As shown in FIG. 12, the cathode condenser 220 has a first water drain valve 221 disposed at its bottom, and a first water passage 222 connecting the first water drain valve 221 and the water tank 124. The cathode condenser 220 has a condenser body 220b having a gas flow passage 220a, and a heat exchanger 220c through which cooling water as a cooling medium (a liquid cooling medium) for cooling the gas flow passage 220a flows. Since warm cathode off-gas having flown into the gas flow passage 220a is cooled by the cooling water of the heat exchanger 220c, the saturated water vapor amount is reduced and condensed water is produced in the gas flow passage 220a. When the condensed water in the gas flow passage 220a reaches a certain level, the first water drain valve 221 is opened so that the condensed water is supplied to the water tank 124 by gravity.

Water in the water tank 124 is changed into pure water by the purifying unit 125 having the ion-exchange resin and then supplied to the water vaporizing unit 128 by the pump (the raw material water feeding source) 126 and the raw material water valve 127, and becomes water vapor to be used in the reforming reaction.

In this preferred embodiment, the exhaust duct 3 is one of those of the first to fifth preferred embodiments, and includes the baffle member 6 facing the exhaust port 5. Since such a baffle member 6 as mentioned above is provided, when the fuel cell system is in power generating operation, the combustion exhaust gas discharged from the combustion unit 102 and the cathode off-gas discharged from the cathode 142 of each of the fuel cells 140 are combined and mixed in the mixing chamber 66 of the exhaust duct 3. Then, the exhaust gases flow along the second baffle portion 62 of the baffle member 6 and are discharged from the exhaust port 5 of the exhaust duct 3 to the outside. Since the baffle member 6 faces the exhaust port 5 of the exhaust duct 3, outside winds are suppressed from entering the exhaust duct 3 during operation of the fuel cell system. Accordingly, backflow of the exhaust gases is suppressed. Therefore, combustion stability in the combustion unit 102 of the reformer 100 is suppressed from being damaged by the entry of outside winds.

In this preferred embodiment, during operation of the fuel cell system, when the cathode off-gas discharged from the cathode condenser 220 has a temperature Tc and the combustion exhaust gas discharged from the combustion exhaust gas condenser 110 has a temperature Tf, generally the temperature Tf is higher than the temperature Tc (Tf>Tc)

By the way, it is possible to employ a system in which the abovementioned combustion exhaust gas and the abovementioned cathode off-gas are combined and mixed and then condensed by a condenser to produce condensed water. In this case, however, since the combustion exhaust gas and the cathode off-gas having a difference in temperature are combined and then condensed, there is a fear that condensed water may not be produced at a sufficient efficiency.

In this respect, in this preferred embodiment, as shown in FIG. 12, the combustion exhaust gas condenser 110 and the cathode condenser 220 are provided separately and independently of each other. Therefore, in the combustion exhaust gas condenser 110 through which the relatively high-temperature combustion exhaust gas flows, the combustion exhaust gas is cooled by the heat exchanger 110c, thereby producing condensed water. In addition, in the cathode condenser 220 through which the relatively low-temperature cathode off-gas flows, the cathode off-gas is cooled by the heat exchanger 220c, thereby producing condensed water. When the operation of producing condensed water from the relatively high-temperature combustion exhaust gas is thus separated from the operation of producing condensed water from the relatively low-temperature cathode off-gas, condensed water is produced at a higher efficiency.

Moreover, in this preferred embodiment, as shown in FIG. 12, the heat exchanger 110c of the combustion exhaust gas condenser 110 and the heat exchanger 220c of the cathode condenser 220 are disposed in series so that the same cooling water can flow through these exchangers. Here, it is possible to employ a system in which cooling water flows first through the relatively high-temperature combustion heat exchanger 110c of the exhaust gas condenser 110 and then flows through the relatively low-temperature heat exchanger 220c of the cathode condenser 220. In this case, however, the temperature of the cooling water rises before flowing through the heat exchanger 220c of the cathode condenser 220. Therefore, although the temperature TA of the cooling water is lower than the relatively low temperature TC of the cathode off-gas, the temperature TA and the temperature TC have a smaller difference. Therefore, in this case, there is a fear that the cathode condenser 220 cannot produce condensed water at a sufficient efficiency.

In this respect, in this preferred embodiment, after cooling water flows first through the heat exchanger 220c of the cathode condenser 220, it flows through the heat exchanger 110c of the combustion exhaust gas condenser 110 and then it reaches a warm water storage tank (not shown), where the warmed water is stored. Thus, this preferred embodiment employs a system in which after condensed water is first produced in the condenser 220 from the relatively low-temperature cathode off-gas, condensed water is produced in the condenser 110 from the relatively high-temperature combustion exhaust gas. As a result, condensed water can be favorably obtained not only in the cathode condenser 220 but also in the combustion exhaust gas condenser 110. Therefore, this preferred embodiment is advantageous in reducing water vapor contained in the exhaust gases to be discharged from the exhaust duct 3 as much as possible. As a result, condensed water is suppressed from being produced on a front surface of the front wall 44 of the exhaust duct 3, and the front surface of the front wall 44 and a front surface 701 of the housing 700 are less prone to getting dirty.

In this preferred embodiment, the cooling water flows through the heat exchanger 170c of the anode condenser 170 before flowing through the heat exchanger 220c of the cathode condenser 220. However, it should be noted that the order of cooling water flow is not limited to this and can be opposite.

By the way, when the fuel cell system is not in power generating operation, since exhaust gases are not discharged from the exhaust port 5 of the exhaust duct 3 to the outside, there is a fear that outside winds or the like together with dust may enter the exhaust duct 3. Dust sometimes contains substances which have harmful effects on purification of condensed water. Here, in this preferred embodiment, when the fuel cell system is not in operation, upon actuation of the pump (the gas supply source, air supply source) 108, air is supplied to the combustion unit 102 and then supplied through the combustion exhaust gas passage 31 and the combustion exhaust gas condenser 110 to the mixing chamber 66 of the exhaust duct 3, and then continuously discharged from the exhaust port 5 of the exhaust duct 3.

Accordingly, even when the fuel cell system is not in power generating operation, there is less possibility that outside winds may enter the exhaust duct 3 through the exhaust port 5. Therefore, dust or the like is suppressed from entering the exhaust duct 3 through the exhaust port 5 of the exhaust duct 3. It is preferable that the number of revolutions per unit time of the pump 108 is decreased compared to when the fuel cells 140 are in power generating operation, but the number can be maintained at the same level, depending on the situations. Namely, this preferred embodiment includes an air discharging means for suppressing dust or the like from entering the exhaust gas passage by positively discharging a gas such as air through the exhaust port 5 when the fuel cell system is not in power generating operation.

In this preferred embodiment, a wind pressure sensor 503 is provided on the front wall 44 of the exhaust duct 3 and signals from the wind pressure sensor 503 are input into the control unit 500. When wind pressure detected by the wind pressure sensor 503 is relatively high, the control unit 500 sends a signal to increase the number of revolutions per unit time of the pump 108, thereby increasing the amount of air to be discharged per unit time from the exhaust port 5 to the outside. On the other hand, when the wind pressure detected by the wind pressure sensor 503 is relatively low, the control unit 500 sends a signal to decrease the number of revolutions per unit time of the pump 108, thereby decreasing the amount of air to be discharged per unit time from the exhaust port 5 to the outside. Because the wind sensor 503 is provided on the front wall 44 of the exhaust duct 3, the wind pressure of winds entering the exhaust duct 3 through the exhaust port 5 can be estimated.

### Seventh Preferred Embodiment

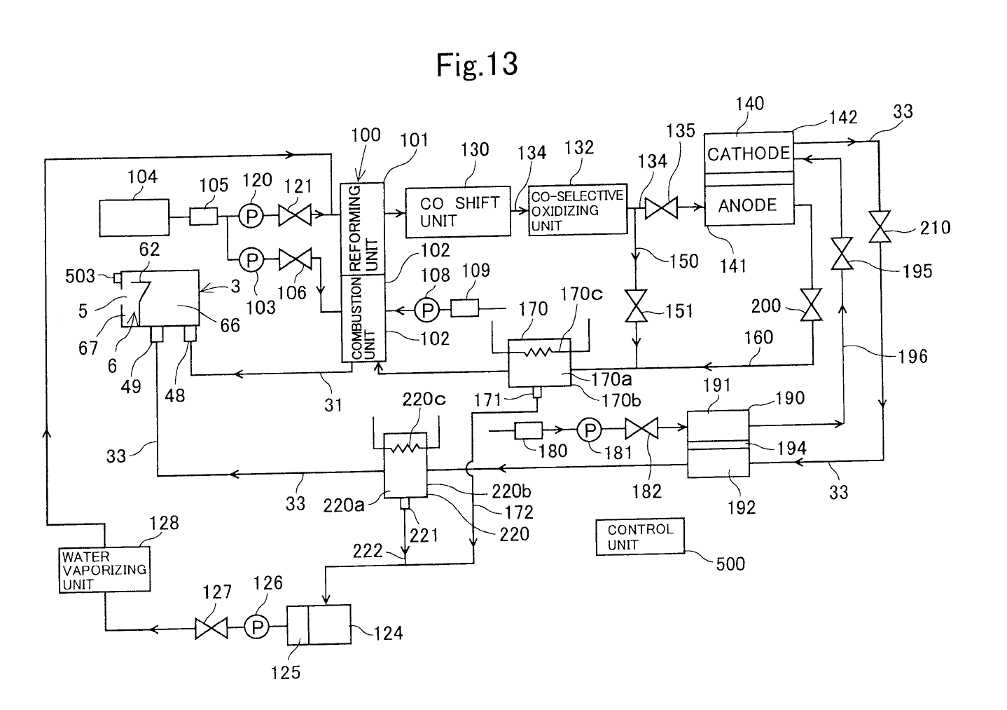

FIG. 13 shows a seventh preferred embodiment of the present invention. This preferred embodiment has basically the same construction, operation and effect as the sixth preferred embodiment. Hereinafter, differences will be mainly described. FIG. 13 shows a fuel cell system. As shown in FIG. 13, this preferred embodiment has the cathode condenser 220 but does not have the combustion exhaust gas condenser 110, which is different from the sixth preferred embodiment.

Therefore, while keeping a high temperature, the combustion exhaust gas discharged from the combustion unit 102 of the reformer 100 flows through the combustion exhaust gas passage 31 to the first cylindrical body 48 of the exhaust duct 3 and then is supplied to the mixing chamber 66. Also in this case, since the baffle member 6 for preventing direct entry of outside air stands close to and faces the exhaust port 5, the baffle member 6 is cooled by outside air supplied to the inside of the exhaust duct 3 through the exhaust port 5. Therefore, the high-temperature combustion exhaust gas is combined and mixed with the cathode off-gas in the mixing chamber 66 and then contacted with and cooled by the baffle member 6 in the exhaust duct 3. As a result, condensed water is easily obtained in the mixing chamber 66 or the exhaust chamber 67. The condensed water is supplied to the cathode condenser 220 through the second cylindrical body 49 and the cathode off-gas passage 33. When condensed water reaches a certain level in the cathode condenser 220, the first water drain valve 221 is opened so that the condensed water is supplied to the water tank 124. Similarly to the sixth preferred embodiment, raw material water from the water tank 124 is changed into pure water by the purifying unit 125 having the ion-exchange resin and then supplied to the water vaporizing unit 128 by the pump (the raw material water feeding source) 126 and the raw material water valve 127, and become water vapor to be used in the reforming reaction.

Also in this preferred embodiment it is preferable that when the fuel cell system is not in operation, upon actuation of the pump (the gas supply source) 108, air is supplied to the combustion unit 102 which is not in burning operation, and then supplied through the combustion exhaust gas passage 31 and the combustion exhaust gas condenser 110 to the mixing chamber 66 of the exhaust duct 3, and then continuously discharged from the exhaust port 5 of the exhaust duct 3.

### Eighth Preferred Embodiment

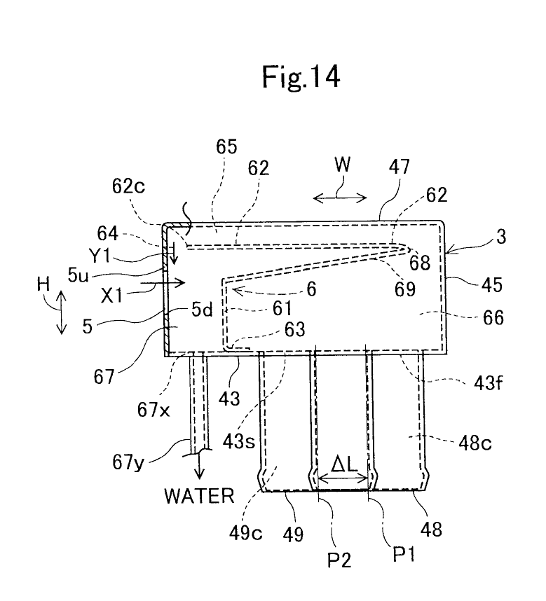

FIG. 14 shows an eighth preferred embodiment of the present invention. This preferred embodiment has basically the same construction, operation and effect as the first preferred embodiment. Hereinafter, differences will be mainly described. As shown in FIG. 14, the baffle member 6 comprises the first baffle portion 61 extending in the extending direction of the exhaust port 5 (the direction of the arrow H) and facing the exhaust port 5, and the second baffle portion 62 connected to the end portion (the upper end portion) of the first baffle portion 61 and extending in the crosswise direction (the direction of the arrow W). The second baffle portion 62 extends along the horizontal direction so as to be located vertically above the first cylindrical body 48 and the second cylindrical body 49. Owing to this, the contact area of the baffle member 6 and the exhaust gases is increased and accordingly the heat exchange area is increased. The increase in the heat exchange area enhances the heat exchange effect of the baffle member 6, which is advantageous in condensing water vapor contained in the exhaust gases to produce condensed water. Therefore, the water content of the exhaust gases to be discharged from the exhaust port 5 is effectively reduced.

### Others

In the above preferred embodiments, the cathode off-gas and the combustion exhaust gas are combined and then discharged from the exhaust port 5 to the outside. However, this invention can be practiced otherwise, and only either of the cathode off-gas and the combustion exhaust gas can be discharged from the exhaust port 5 to the outside. In the above preferred embodiments, cooling water flows first through the heat exchanger 220c of the cathode condenser 220 and then flows through the heat exchanger 110c of the combustion exhaust gas condenser 110, but this order of cooling water flow can be opposite. The ion-exchange membrane of each of the fuel cells is not limited to those formed of solid polymer but can be those formed of inorganic materials. This invention should not be limited to the preferred embodiments described above and shown in the drawings, and various modifications are possible without departing the gist of the present invention. A structure unique to one preferred embodiment can be applied to other preferred embodiments.

The following technical concept can also be grasped from the above description.

In a fuel cell system including a fuel cell having an anode and a cathode, an anode fluid supply unit for supplying anode fluid to the anode of the fuel cell, a cathode fluid supply unit for supplying cathode fluid to the cathode of the fuel cell, and an exhaust gas passage having an exhaust port for discharging exhaust gases generated during operation of the fuel cell to the outside, the fuel cell system includes a backflow suppressing unit for suppressing outside air from entering the exhaust gas passage through the exhaust port by discharging a gas from the exhaust port when the fuel cell system is not in operation. In this case, even when the fuel cell system is not in operation, outside air is suppressed from entering the exhaust gas passage through the exhaust port by discharging a gas from the exhaust port.

### INDUSTRIAL APPLICABILITY

This invention can be applicable, for example, to fuel cell systems for stationary use, vehicle use, electric appliance use, electronic device use, and portable use.

1.-13. (canceled)

14. A fuel cell system including a fuel cell having an anode and a cathode, an anode fluid supply unit for supplying anode fluid to the anode of the fuel cell, a cathode fluid supply unit for supplying cathode fluid to the cathode of the fuel cell, and an exhaust gas passage having an exhaust port for discharging exhaust gases generated during operation of the fuel cell to the outside,
the exhaust gas passage including a backflow suppressing unit at an end portion of the exhaust gas passage on the side of the exhaust port,
wherein the anode fluid supply unit includes a reforming unit for generating anode gas to be supplied to the anode of the fuel cell from a raw material, and a combustion unit for heating the reforming unit,
the exhaust gas passage comprises a first exhaust gas passage connected to the combustion unit, and a second exhaust gas passage having the exhaust port and having a larger flow passage cross sectional area than that of the first exhaust gas passage, and
the end portion of the exhaust gas passage on the side of the exhaust port is the second exhaust gas passage.

15. A fuel cell system including a fuel cell having an anode and a cathode, an anode fluid supply unit for supplying anode fluid to the anode of the fuel cell, a cathode fluid supply unit for supplying cathode fluid to the cathode of the fuel cell, and an exhaust gas passage having an exhaust port for discharging exhaust gases generated during operation of the fuel cell to the outside,
the exhaust gas passage including a backflow suppressing unit at an end portion of the exhaust gas passage on the side of the exhaust port,
wherein the end portion of the exhaust gas passage on the side of the exhaust port has a mixing room for mixing combustion exhaust gas discharged from a combustion unit of the anode fluid supply unit and cathode off-gas discharged from the cathode of the fuel cell.

16. A fuel cell system including a fuel cell having an anode and a cathode, an anode fluid supply unit for supplying anode fluid to the anode of the fuel cell, a cathode fluid supply unit for supplying cathode fluid to the cathode of the fuel cell, and an exhaust gas passage having an exhaust port for discharging exhaust gases generated during operation of the fuel cell to the outside,
the exhaust gas passage including a backflow suppressing unit at an end portion of the exhaust gas passage on the side of the exhaust port,
wherein the fuel cell system includes a condenser, and the end portion of the exhaust gas passage on the side of the exhaust port discharges condensed water present in the end portion on the side of the exhaust port by gravity or returns the condensed water to the condenser by gravity.

17. A fuel cell system including a fuel cell having an anode and a cathode, an anode fluid supply unit for supplying anode fluid to the anode of the fuel cell, a cathode fluid supply unit for supplying cathode fluid to the cathode of the fuel cell, and an exhaust gas passage having an exhaust port for discharging exhaust gases generated during operation of the fuel cell to the outside,
the exhaust gas passage including a backflow suppressing unit at an end portion of the exhaust gas passage on the side of the exhaust port,
wherein the backflow suppressing unit is formed of a baffle member facing the exhaust port, and
wherein when the baffle member and the exhaust port are projected in a vertical direction to the baffle member and the exhaust port, the shape of a projection of the baffle member overlaps that of the exhaust port and the area of the projection of the baffle member is larger than that of the exhaust port.

18. A fuel cell system including a fuel cell having an anode and a cathode, an anode fluid supply unit for supplying anode fluid to the anode of the fuel cell, a cathode fluid supply unit for supplying cathode fluid to the cathode of the fuel cell, and an exhaust gas passage having an exhaust port for discharging exhaust gases generated during operation of the fuel cell to the outside,
the exhaust gas passage including a backflow suppressing unit at an end portion of the exhaust gas passage on the side of the exhaust port,
wherein the backflow suppressing unit is formed of a baffle member facing the exhaust port, and
wherein the baffle member comprises a first baffle portion extending in an extending direction of the exhaust port and facing the exhaust port, and a second baffle portion connected to an end portion of the first baffle portion and extending in a crosswise direction to the extending direction of the exhaust port.

19. A fuel cell system including a fuel cell having an anode and a cathode, an anode fluid supply unit for supplying anode fluid to the anode of the fuel cell, a cathode fluid supply unit for supplying cathode fluid to the cathode of the fuel cell, and an exhaust gas passage having an exhaust port for discharging exhaust gases generated during operation of the fuel cell to the outside,
the exhaust gas passage including a backflow suppressing unit at an end portion of the exhaust gas passage on the side of the exhaust port,
wherein the backflow suppressing unit is formed of a baffle member facing the exhaust port, and
wherein the baffle member has a heat exchange fin.

20. A fuel cell system including a fuel cell having an anode and a cathode, an anode fluid supply unit for supplying anode fluid to the anode of the fuel cell, a cathode fluid supply unit for supplying cathode fluid to the cathode of the fuel cell, and an exhaust gas passage having an exhaust port for discharging exhaust gases generated during operation of the fuel cell to the outside,
the exhaust gas passage including a backflow suppressing unit at an end portion of the exhaust gas passage on the side of the exhaust port,
wherein the backflow suppressing unit is formed by bending a passage portion disposed at the side of the exhaust port in the exhaust gas passage, and
wherein when a baffle member for forming the passage portion and the exhaust port are projected in a vertical direction to the baffle member and the exhaust port, the shape of a projection of the baffle member overlaps that of the exhaust port and the area of the projection of the baffle member is larger than that of the exhaust port.

21. A fuel cell system including a fuel cell having an anode and a cathode, an anode fluid supply unit for supplying anode fluid to the anode of the fuel cell, a cathode fluid supply unit for supplying cathode fluid to the cathode of the fuel cell, and an exhaust gas passage having an exhaust port for discharging exhaust gases generated during operation of the fuel cell to the outside,
the exhaust gas passage including a backflow suppressing unit at an end portion of the exhaust gas passage on the side of the exhaust port,
wherein the backflow suppressing unit is formed by bending a passage portion disposed at the side of the exhaust port in the exhaust gas passage, and
wherein a baffle member for forming the backflow suppressing unit comprises a first baffle portion extending in an extending direction of the exhaust port arid facing the exhaust port, and a second baffle portion connected to an end portion of the first baffle portion and extending in a crosswise direction to the extending direction of the exhaust port.

22. A fuel cell system including a fuel cell having an anode and a cathode, an anode fluid supply unit for supplying anode fluid to the anode of the fuel cell, a cathode fluid supply unit for supplying cathode fluid to the cathode of the fuel cell, and an exhaust gas passage having an exhaust port for discharging exhaust gases generated during operation of the fuel cell to the outside,
the exhaust gas passage including a backflow suppressing unit at an end portion of the exhaust gas passage on the side of the exhaust port,
wherein the backflow suppressing unit is formed by bending a passage portion disposed at the side of the exhaust port in the exhaust gas passage, and
wherein a baffle member for forming the backflow suppressing unit has a heat exchange fin.

23. A fuel cell system including a fuel cell having an anode and a cathode, an anode fluid supply unit for supplying anode fluid to the anode of the fuel cell, a cathode fluid supply unit for supplying cathode fluid to the cathode of the fuel cell, and an exhaust gas passage having an exhaust port for discharging exhaust gases generated during operation of the fuel cell to the outside, the fuel cell system including a backflow suppressing unit,
wherein the backflow suppressing unit includes a gas discharging unit for suppressing outside air from entering the exhaust gas passage through the exhaust port by discharging a gas from the exhaust port when the fuel cell system is not in operation, and the backflow suppressing unit includes a wind pressure sensor for detecting wind pressure of an outside wind, and
when the fuel cell system is not in operation, the flow rate of the gas to be discharged per unit time from the exhaust port is determined based on the wind pressure of the outside wind detected by the wind pressure sensor in such a manner that the flow rate of the gas is increased when the wind pressure of the outside wind detected by the wind pressure sensor relatively high, and in such a manner that the flow rate of the gas is decreased when the wind pressure of the outside wind detected by the wind pressure sensor relatively low.

24. The fuel cell system according to claims 14, wherein the second exhaust gas passage has a container shape.
